(19) United States
(12) Patent Application Publication
(10) Pub. No.: US 2026/0364863 A1
(43) Pub. Date: Nov. 19, 2026

(54) COMPOSITE INJECTION LAMINATED ARTICLE

(71) Applicant: PepsiCo, Inc., Purchase, NY (US)

(72) Inventors: Girish DESHPANDE, Carmel, NY (US); Jes Tougaard GRAM, George Town (KY)

(21) Appl. No.: 19/208,948

(22) Filed: May 15, 2025

(51) Int. Cl. B29C 45/14; B29C 45/00; B29C 65/48; B29L 31/00; B65D 1/02; B65D 23/08

(52) U.S. Cl. CPC B29C 45/14786; B29C 45/14795; B29C 65/48; B65D 1/0207; B65D 1/0246; B65D 1/0276; B65D 23/0807; B29C 2045/0079; B29L 2031/7158

(57) ABSTRACT

A fitment for a bottle includes a fiber ring constructed of fiber based material. The fiber based material includes a mass of fibers defining interstices among the fibers. The fitment also includes a plastic collar comprising a plastic. The plastic collar is joined to the fiber ring. Some of the plastic of the plastic collar extends permeates some of the interstices of the fiber ring.

### BACKGROUND

Packages made at least partially of more environmentally friendly alternatives to conventional packaging materials have been gaining consumer and commercial acceptance. However, there are a number of challenges associated with the use of environmentally friendly materials and packaging. For example, some easily recyclable and light weight materials may lack durability or the capability to reliably create a water-tight seal. Thus, some materials with preferable characteristics from an environmental perspective may be suitable for some parts of an article of packaging while being unsuitable for other parts of the same article of packaging.

In response to these challenges, some packages have been made by assembling separately manufactured components made of different materials. For example, manufacture of some packages has included producing components of easily recyclable material separately from components of conventional packaging material, then joining the separately produced components together. These solutions also can also present difficulties. Components made of different materials can be difficult to join together securely. Additionally, components with small thicknesses or overall sizes can be impractical to manufacture. As a result, minimum practical part sizes for the components made from conventional packaging material may result in the conventional packaging material constituting a relatively large proportion of the assembled article.

### BRIEF SUMMARY

While fiber based materials, such as paper, tend to be easily recyclable, other materials are useful for certain applications. For example, plastic can be used to make liquid-tight connections, such as by pressing two plastic elements together to create a seal. Plastic is also simple to sterilize. Additionally, some plastics have useful mechanical characteristics, such as relatively high yield strength. Thus, some plastics can support relatively high closing forces when used in closures for bottles, which is why plastic is commonly used to create fitments and closures for bottles that store beverages. However, in bottles having plastic fitments but otherwise mostly fiber based construction, the plastic of the fitment tends to make up a significant proportion of the total weight of each bottle. Some such bottles may therefore lack the minimum amount of fiber by total weight required for recyclability in some jurisdictions. Reducing the amount of plastic in a fitment to be applied in an otherwise mostly fiber based bottle may therefore make the bottle as a whole recyclable and have a sizable and positive environmental impact. Using a component constructed of fiber based material as a base upon which a plastic component can be formed to create a composite article that achieves some of the advantages of plastic while being more environmentally friendly by using less plastic than would be necessary to construct the same article entirely from plastic. For example, a fitment made according to some techniques within the present disclosure may achieve a reduction in plastic weight by as much as 40% as compared to an all-plastic fitment of the same design. However, while a fitment is used in some examples herein, the techniques of the present disclosure are applicable to the construction of a wide variety of other articles.

A need exists for a composite article including a porous or fibrous component and another component of different material formed securely on the porous or fibrous component. Accordingly, aspects of the present disclosure are directed to an article that includes a fiber component and a non-fiber component formed on the fiber component. The material from which the non-fiber component is formed can permeate some of the fiber component to attach the non-fiber component to the fiber component securely. In some embodiments, the material from which the non-fiber component is formed can permeate a portion of the fiber component by extending into interstices between fibers forming the fiber component.

Further aspects of the present disclosure are directed to processes for forming a composite article that includes a fiber component and a non-fiber component formed on the fiber component. The processes can include creating the fiber component, then placing the fiber component in an injection mold cavity. The processes can also include injecting a non-fiber material into the cavity while the fiber component is within the cavity. The injected non-fiber material can become the non-fiber component formed on the fiber component. The non-fiber material can be injected at temperatures and pressures that cause the non-fiber material to permeate at least part of the fiber component. The injection mold can be constructed to facilitate the permeation of the injected non-fiber material into the fiber component. For example, gates through which the non-fiber material can be injected can be placed near the intended position of the fiber component within the mold cavity.

Further aspects of the present disclosure are directed to a container including an assembly of a composite fitment and a vessel. The composite fitment can include a fiber component and a plastic component formed on the fiber component. The plastic of the plastic component can permeate part of the fiber component to join the plastic component to the fiber component securely. In some embodiments, the plastic of the plastic component can permeate part of the fiber component by extending into interstices between fibers forming the fiber component. The fiber component can be constructed of fiber based material including a mass of fibers. The mass of fibers can define interstices between the fibers. The plastic of the plastic component can permeate the interstices defined between the fibers. The vessel can be constructed at least partially of fiber. The composite fitment can be joined to the vessel by creating a bond between the fiber component of the fitment and the fiber material of the vessel. The container can also include a coating applied to both the fitment and the vessel.

Aspects of the present disclosure relate to a fitment for a bottle. The fitment can include a fiber ring constructed of fiber based material. The fiber based material can include a mass of fibers defining interstices among the fibers. The fitment can also include a plastic collar. The plastic collar can be formed of plastic. The plastic collar can be joined to the fiber ring. Some of the plastic can permeate some of the interstices of the fiber ring.

In some embodiments according to any of the foregoing, the plastic collar can include a threaded portion.

In some embodiments according to any of the foregoing, the threaded portion can be externally threaded.

Further aspects of the present disclosure relate to a bottle including a vessel and a fitment according to any of the foregoing embodiments. The vessel can include an opening, and the fitment can be positioned at the opening.

In some embodiments according to any of the foregoing, the vessel can include a wall. The wall can include fiber based material.

In some embodiments according to any of the foregoing, fiber can include at least 90% of the bottle by weight.

In some embodiments according to any of the foregoing, fiber can include at least 95% of the bottle by weight.

In some embodiments according to any of the foregoing, the bottle can include a binder that binds the fiber ring to the vessel.

In some embodiments according to any of the foregoing, the vessel can include a fiber portion constructed of fiber based material. The binder can bind the fiber portion of the vessel to the fiber ring.

In some embodiments according to any of the foregoing, the bottle can include a coating applied to interior facing surfaces of the fitment and the vessel.

In some embodiments according to any of the foregoing, the bottle can include an interior of the bottle defined within the vessel. The bottle can also include a joint between the fiber ring and the vessel. The coating can seal off the joint from the interior of the bottle.

Further aspects of the present disclosure relate to a method of manufacture. The method can include forming a composite article by injecting a molten material into an injection mold cavity while a fiber based object is disposed in the injection mold cavity. The molten material can be injected into the injection mold cavity at a great enough pressure to force the molten material into interstices between fibers of the fiber based object.

In some embodiments according to any of the foregoing, the method can include binding the fiber based object to a fiber based article after forming the composite article.

In some embodiments according to any of the foregoing, the composite article can be a fitment for a bottle. The molten material can be a plastic. The fiber based object can be a fiber ring.

In some embodiments according to any of the foregoing, the injection mold cavity can have a shape of a fitment for a bottle.

In some embodiments according to any of the foregoing, the injection mold cavity can include a finish portion. The injection mold cavity can also have a thread portion adjoining the finish portion.

In some embodiments according to any of the foregoing, the method can include injecting the plastic into the injection mold cavity while the fiber ring extends into the finish portion.

In some embodiments according to any of the foregoing, the method can include injecting the plastic into the injection mold cavity through a gate that opens into the finish portion.

In some embodiments according to any of the foregoing, the gate can be less than one millimeter away from the fiber ring.

In some embodiments according to any of the foregoing, the method can include injecting the plastic into the injection mold cavity in an outward direction relative to a central axis of the fiber ring.

Further aspects of the present disclosure relate to a method of lightweighting an injection molded article of manufacture. The method can comprise subdividing a net shape of the injection molded article of manufacture into a first section and a second section. The first section can comprise a region to be formed of a porous component. The second section can comprise a region to be formed of injection molded material. The method can also comprise fabricating a porous object having a shape matching a portion of the first section. The method can also comprise placing the porous object into an injection mold cavity. The method can also comprise injecting a molten material into the injection mold cavity at a great enough pressure to force the molten material into pores in the porous object.

In some embodiments according to any of the foregoing, the subdividing step comprises identifying a first surface of the injection molded article of manufacture that does not have a purpose that requires the injection molded material. The subdividing step can also comprise identifying a second surface of the injection molded article that has a purpose that requires the injection molded material. The subdividing step can comprise including the first surface in the first section and including the second surface in the second section.

In some embodiments according to any of the foregoing, the porous object can be a first porous object. The method can comprise forming a porous assembly having a shape matching the first section, wherein the porous assembly comprises the first porous object and a second porous object.

In some embodiments according to any of the foregoing, the method can comprise forming the porous assembly after injecting the molten material into the injection mold cavity.

In some embodiments according to any of the foregoing, the method can comprise selecting a binder to bind the first porous object to the second porous object at a joint. The method can also comprise identifying a third surface of the porous assembly that has a purpose incompatible with the binder. The method can also comprise identifying a coating location at which coating, when placed, will seal the joint away from the third surface.

### BRIEF DESCRIPTION OF THE DRAWINGS

FIG. 1A is a perspective view of a fitment according to some aspects of the present disclosure.

FIG. 1B is a cross-sectional view of the fitment of FIG. 1A.

FIG. 2A is a perspective view of a fiber component of the fitment of FIG. 1A

FIG. 2B is a cross-sectional view of an injection mold and the fiber component of FIG. 2A.

FIG. 3A is a cross-sectional view of the fitment of FIG. 1A and a vessel

FIG. 3B is a cross-sectional view of a portion of an assembly of the fitment of FIG. 1A and the vessel of FIG. 3A.

FIG. 3C is a cross-sectional view of the assembly of FIG. 3B.

FIG. 3D is a cross-sectional view of a bottle that includes the assembly of FIG. 3B.

FIG. 3E is a cross-sectional view of a container that includes the bottle of FIG. 3D

FIG. 4 is a cross-sectional view of a closure.

FIG. 5 is a flowchart of a method of lightweighting an article of manufacture according to an aspect of the present disclosure.

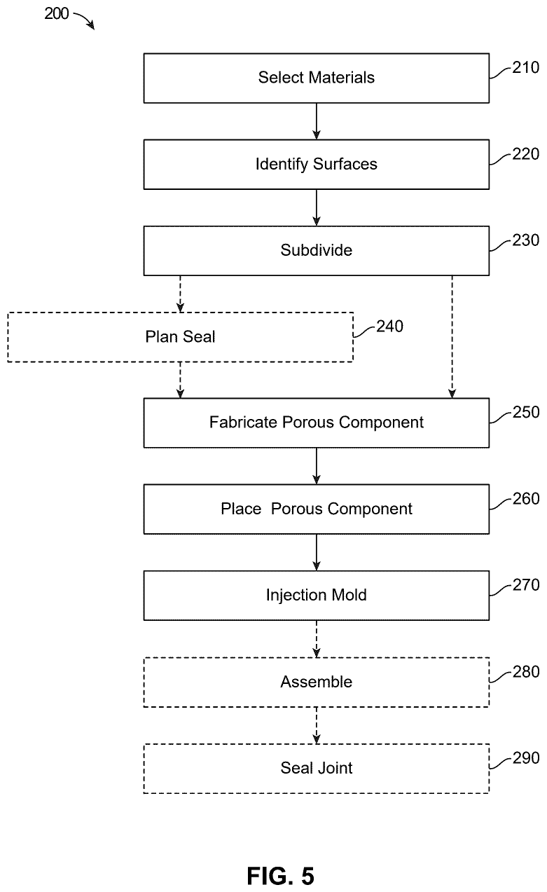

### DETAILED DESCRIPTION

The present invention will now be described in detail with reference to embodiments thereof as illustrated in the accompanying drawings. References to “one embodiment,” “an embodiment,” “an example embodiment,” “some embodiments,” etc., indicate that the embodiment described may include a particular feature, structure, or characteristic, but every embodiment described may not necessarily include that particular feature, structure, or characteristic. Similarly, other embodiments may include additional features, structures, or characteristics. Moreover, such phrases are not necessarily referring to the same embodiment. When a particular feature, structure, or characteristic is described in connection with the embodiment, it is submitted that it is within the knowledge of one skilled in the art to effect such feature, structure, or characteristic in connection with other embodiments whether or not explicitly described.

The terms “invention,” “present invention,” “disclosure,” or “present disclosure” as used herein are non-limiting terms and are not intended to refer to any single embodiment of the particular invention but encompasses all possible embodiments as described in the application.

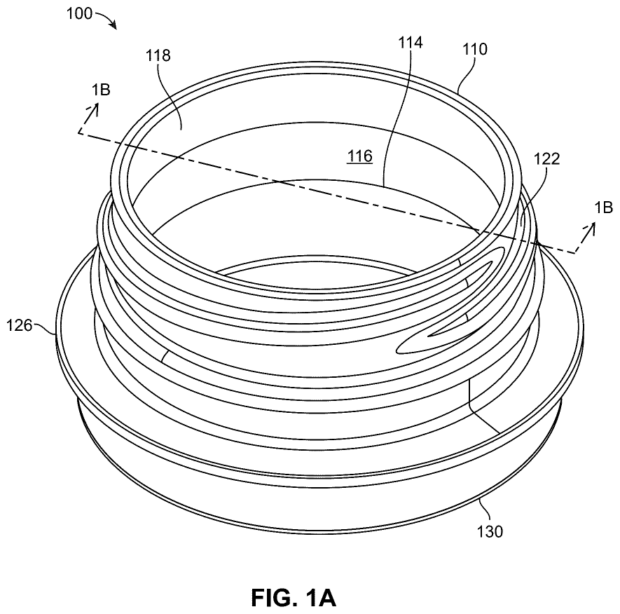

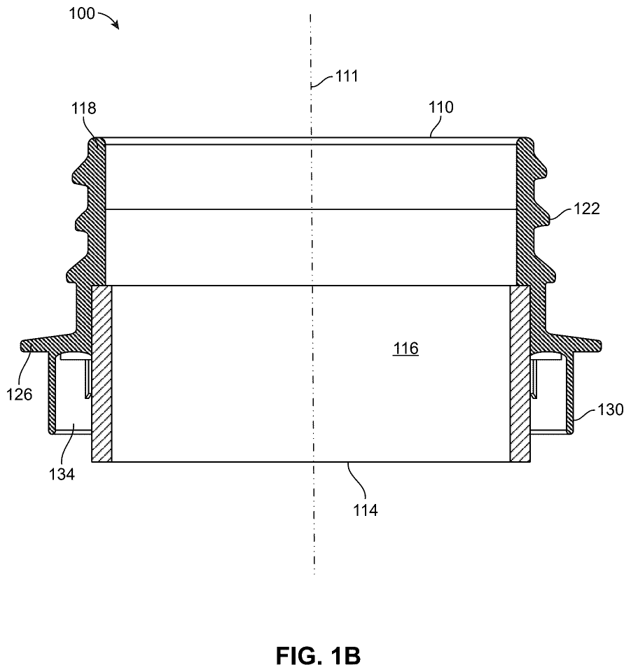

FIGS. 1A and 1B show a fitment 100 for a composite container. Fitment 100 itself can be a composite article in some embodiments. Fitment 100 of the illustrated embodiment is a composite fitment.

Fitment 100 includes a plastic component 110 and a fiber component 114. Fiber component 114 of the illustrated embodiment is a ring of fiber based material. In some embodiments, the fiber based material can be a solid material formed from a fiber pulp precursor. However, fiber component 114 according to other embodiments can have a shape other than a ring shape.

Plastic component 110 of the illustrated example is a plastic collar formed on fiber component 114. Plastic component 110 of the illustrated example has a generally annular shape positioned coaxially with the ring shape of fiber component 114. However, plastic component 110 can have other shapes in other embodiments.

Plastic component 110 can be made of any type of plastic. Accordingly, plastic component 110 can include natural resin, synthetic polymers, or both. In some embodiments, the plastic can be a polymer resin. In some embodiments, the plastic can be a product of cooling a molten substance. In some embodiments, the plastic can be a solid remnant of a solution. In further embodiments, the plastic can be any type of plastic usable for beverage containers, such as, for example, polyethylene terephthalate (“PET”), polypropylene, high density polyethylene (“HDPE”), or any combination thereof.

Fiber component 114 can be made of a fiber based material, such as, for example, wood pulp derived material, paper fibers, cellulose, or other natural fibers. The fiber based material can include a mass of fibers interconnected to each other such that they together form a solid component. The mass of fibers can define interstices between the fibers. In some embodiments, the fibrous material can be an easily recyclable material. In some embodiments, the fibrous material can be a fiber pulp.

Plastic component 110 can be joined to fiber component 114. In some embodiments, such as the illustrated embodiment, fiber component 114 can be embedded in plastic component 110. Some of the plastic of plastic component 110 can permeate a part of fiber component 114. In some embodiments, the plastic of plastic component 110 can permeate part of fiber component 114 by extending into interstices between fibers forming fiber component 114. The plastic of plastic component 110 can permeate the interstices defined in at least a portion of the mass of fibers of the fiber based material of which fiber component 114 is constructed. Thus, in some embodiments, some of the plastic of plastic component 110 extends into fiber component 114. In some embodiments, fitment 100 can be made in part by forming plastic component 110 on fiber component 114 in a manner that causes the plastic of plastic component 110 to extend continuously into interstices between fibers while in a molten or otherwise liquid state before solidifying.

Fitment 100 of the illustrated embodiment includes a passage 116. Passage 116 of the illustrated embodiment extends through both plastic component 110 and fiber component 114. Passage 116 according to other embodiments can extend through plastic component 110 without extending through fiber component 114. Passage 116 according to other embodiments can extend through fiber component 114 without extending through plastic component 110. Passage 116 can extend along a central axis 111 of fitment 100.

Fitment 100 of the illustrated embodiment includes a finish 118. Finish 118 can be configured to act as a finish of a bottle when fitment 100 is assembled together with a vessel to form a bottle. Passage 116 can extend through finish 118. Finish 118 of the illustrated example is cylindrical. However, finish 118 can be shaped otherwise in other examples.

Fitment 100 further includes threading 122 on finish 118. Threading 122 defines a threaded portion of fitment 100. Threading 122 enables a closure, such as a threaded cap, to be engaged to fitment 100. Fitment 100 can therefore be assembled together with a closure and a vessel to form a closed container. Threading 122 of the illustrated embodiment is external threading. In some embodiments, threading 122 can be internal threading. In further examples, fitment 100 can include other features for engaging a closure instead of threading 122. In still further embodiments, fitment 100 can include an integrated closure. In some embodiments, plastic component 110 includes threading 122. Thus, in such embodiments, threading 122 can be formed of plastic. Threading 122 can therefore be formed of plastic without fitment 100 being entirely formed of plastic. Material and construction of fiber component 114 can therefore be chosen to prioritize qualities such as light weight or recyclability without affecting threading 122. Similarly, material and construction of plastic component 110 can be selected to prioritize the ability of threading 122 to reliably engage a closure while having less impact on the overall weight or recyclability of fitment 100 than the choice of material and construction would have on a fitment made entirely of plastic.

As shown in FIG. 1B, fiber component 114 can extend into finish 118. Fitment 100 can include plastic portion provided by plastic component 110 and a fiber portion provided by fiber component 114. The plastic portion of fitment 100 can facilitate engagement of a closure. For example, in the illustrated embodiment, the plastic portion of fitment 100 facilitates engagement of a closure by supporting threading 122. Accordingly, because plastic component 110 includes both threading 122 and a portion of finish 118, plastic component 110 includes the threaded portion of fitment 100 as a whole. Thus, fitment 100 can be constructed such that fiber component 114 provides structural stability at relatively little weight while plastic component 110 provides features configured to engage a closure. As shown in the illustrated embodiment, finish 118 itself can include a plastic portion provided by a part of plastic component 110 and a fiber portion provided by a part of fiber component 114. The plastic portion of finish 118 can facilitate engagement of a closure. For example, in the illustrated embodiment, the plastic portion of finish 118 facilitates engagement of a closure by supporting threading 118.

Plastic component 110 of the illustrated embodiment includes a barrier 130. Barrier 130 is spaced from fiber component 114 and thereby defines a gap 134 between fiber component 114 and barrier 130. Barrier 130 of the illustrated embodiment surrounds a portion of fiber component 114. Gap 134 of the illustrated embodiment therefore also surrounds the portion of fiber component 114. However, in some embodiments, barrier 130 may be positioned adjacent to a portion of fiber component 114 without surrounding any part of fiber component 114. In such other embodiments, gap 134 would be defined between barrier 130 and fiber component 114, meaning gap 134 would not surround fiber component 114 either. In some embodiments, plastic component 110 may include multiple barriers 130 spaced apart from one another and collectively extending around fiber component 114. In such examples, each barrier 130 may define a respective gap 134 between the barrier 130 and fiber component 114.

Barrier 130 can impede access to objects received in gap 134. For example, if a rim of a vessel is received in gap 134, barrier 130 can impede access to the rim of the vessel. By impeding access to the rim of the vessel, barrier 130 can inhibit removal of fitment 100 from the vessel. Further, barrier 130 can facilitate attachment of fitment 100 to other objects, such as the rim of a vessel, because fitment 100 can be attached by friction to objects received with an interference fit into gap 134.

In the illustrated embodiment, barrier 130 is cylindrical in shape. Accordingly, barrier 130 of the illustrated embodiment is a hoop. However, barrier 130 can be shaped otherwise in other embodiments. In the illustrated embodiment, a distance across barrier 130 normal to central axis 111 is greater than a distance across finish 118 normal to central axis 111. Where both finish 118 and barrier 130 are cylindrical in shape, such as in the illustrated embodiment, barrier 130 can have a greater diameter than finish 118 normal to central axis 111.

Fitment 100 of the illustrated embodiment further includes flange 126. In some embodiments, flange 126 can be used for any purpose for which radial protrusions from known bottles and preforms can be used. Flange 126 of the illustrated embodiment can be used to support a bottle that includes fitment 100 while the bottle is being transported along a bottle filling line. Flange 126 can extend radially away from central axis 111. Barrier 130 can extend from flange 126. In some embodiments, barrier 130 can extend from flange 126 in a direction away from finish 118. Thus, in some embodiments, gap 134 can be defined between barrier 130 and a different portion of fiber component 114 than the portion of fiber component 114 that extends into finish 118. Further, in some embodiments, barrier 130 can surround a different portion of fiber component 114 than the portion of fiber component 114 that extends into finish 118.

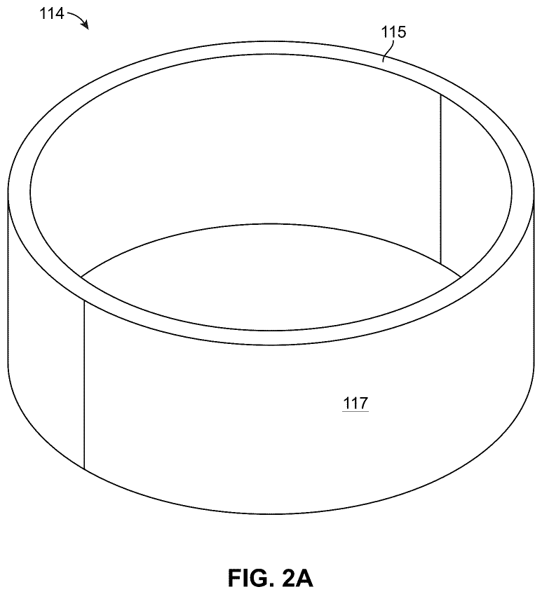

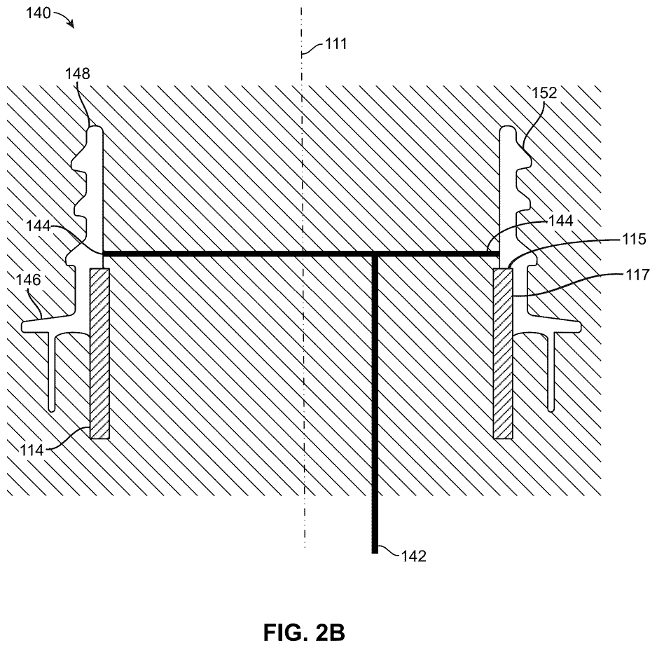

FIGS. 2A and 2B show stages in a process of fabricating fitment 100. A process of fabricating fitment 100 can begin by forming a fiber component 114 as shown in FIG. 2A. In some embodiments, fiber component 114 can be formed by filling a mold with fluid mixture containing fiber, such as fiber pulp, and drying the mixture. In some embodiments, the fiber pulp can be wood pulp. In some embodiments, the mixture can be dried by heating or by mechanically expelling liquid from the mixture. In further embodiments, fiber component 114 can be formed by compression molding fiber into an intended shape, such as the illustrated ring shape.

Fiber component 114 is a porous article formed by a mass of interlocking fibers. The mass of interlocking fibers includes interstices formed between fibers positioned near one another within the mass. The interstices form the pores of fiber component 114. Fiber component 114 has an overall shape provided collectively by the fibers among the mass. Fiber component's 114 overall shape has an exterior defined at the outer boundary of the mass of fibers. The outer boundary for this purpose encompasses the pores formed between the fibers. Thus, the exterior of fiber component 114 can be considered to have identifiable, generally continuous surfaces provided collectively by the mass of fibers. In particular, fiber component 114 has an upper surface 115 and a radially outer surface 117. In some embodiments, fiber component 114 may also have a lower surface that is opposed to upper surface 115 and a radially inner surface that is opposed to radially outer surface 117.

Turning to FIG. 2B, fiber component 114 can be placed in a cavity 146 of an injection mold 140. Cavity 146 can match an intended net shape of fitment 100. In some such embodiments, cavity 146 has a shape of a fitment for a bottle. Thus, fiber component 114 can be disposed within cavity 146 such that a remaining empty portion of cavity 146 matches an intended shape of plastic component 110. Accordingly, cavity 146 of the illustrated example includes a finish portion 148 and a thread portion 152 that adjoins finish portion 148. Part of finish portion 148 is a negative of the shape of finish 118 and thread portion 152 is a negative of the shape of threading 122 such that material injected into cavity 146 can form threading 122 and a plastic portion of finish 118. Cavity 146 can also include portions shaped as negatives of all other features of plastic component 110.

After placement of fiber component 114 into cavity 146 but before other material is injected into cavity 146, one or more exterior surfaces of fiber component 114 can be exposed to empty space within cavity 146. In the illustrated embodiment, upper surface 115 and radially outer surface 117 are exposed to empty space within cavity 146. Material injected into cavity 146 while fiber component 114 is disposed within cavity 146 may therefore reach upper surface 115 and radially outer surface 117 of fiber component 114.

Plastic can be injected into cavity 146 while fiber component 114 is disposed within cavity 146 to create fitment 100. In the illustrated embodiment, fiber component 114 can be disposed in cavity 146 such that fiber component 114 extends into finish portion 148 of cavity 146. Plastic can therefore be injected into cavity 146 while fiber component 114 is positioned to extend into finish portion 148 of cavity 146 to create a composite component such as fitment 100 having a finish 118 that includes both a fiber portion and a plastic portion.

Injection mold 140 can include an injection channel 142 through which material can be injected into cavity 146. Injection mold 140 can also include gates 144 where material can pass from injection channel 142 into cavity 146.

In some embodiments, material can be injected through injection channel 142 in a manner that causes the material to permeate at least part of fiber component 100. For example, material can be injected at an elevated pressure. In further examples, material can be injected at an elevated temperature. The material injected into cavity 146 while fiber component 114 is disposed within cavity 146 can be a molten material. In some embodiments, the injected material can be molten or otherwise liquid material that can solidify to become plastic component 110 after being injected.

In some embodiments, the injected material can be can be injected in a manner that causes the injected material to extend continuously into interstices between fibers while in a molten or otherwise liquid state before solidifying. Thus, in the illustrated embodiment, injected plastic can pass through portions of the exterior of fiber component 114 that are exposed within cavity 146, such as upper surface 115 and radially outer surface 117, to reach interstices within fiber component 114. The plastic extending continuously into interstices between fibers can extend beyond and behind the fibers that form the exterior surface of fiber component 114 to interlock with the fibers. In some embodiments, the plastic extending continuously into interstices between fibers can interconnect across interstices to form a network of plastic within fiber component 114 that interlocks with the fibers. In some such embodiments, the molten material can be plastic.

In some embodiments, the molten material can be injected at a pressure from 300 psi to 600 psi. In further embodiments, the molten material can be injected at a pressure from 350 psi to 500 psi. In further embodiments, the molten material can be injected at a pressure from 400 psi to 450 psi. For example, in embodiments wherein fiber component 114 is made of paper fiber and the molten material is plastic, such as polypropylene or HDPE, injection at pressures from 400 psi to 450 psi and adequate temperature can result in suitable permeation of the interstices of fiber component 114 by the molten material to create a strong bond between fiber component 114 and the resulting plastic component 110. Injection pressures can vary depending on the respective compositions of fiber component 114 and the injected material, as well as parameters of the injection, such as the temperature of the molten material and the dimensions of mold cavity 146.

The above described interlock between injected plastic and fibers of fiber component 114 can create a secure connection between fiber component 114 and plastic component 110 when the injected plastic becomes plastic component 110. The connection between fiber component 114 and plastic component 110 created by forming plastic component 110 on fiber component 114 this way can be more secure than could easily be achieved by other methods of joining already-formed plastic components to fiber components. Forming plastic component 110 on fiber component 110 this way, or more generally forming a first component from a flowable material upon a second component of a porous material, can therefore overcome difficulties associated with joining components of dissimilar materials.

Moreover, once formed, fitment 100 and other composite elements created by forming a first component from a flowable material upon a second component of a porous material can be made part of larger assemblies including like-to-like joints. For example, because reliable techniques for creating strong joints between two porous components exist, fitment 100 can be securely attached to another porous object by joining fiber component 114 to the porous object. Additionally, because reliable techniques for creating strong joints between two components formed from similar flowable materials exist, such as techniques for joining plastic components together, fitment 100 can be securely attached to another plastic object by joining plastic component 110 to the plastic object.

In the illustrated embodiment, gates 144 are positioned on radially inner surfaces of cavity 146. Thus, in some embodiments, material can be injected into cavity in an outward direction relative to central axis 111. In some embodiments, material can be injected into cavity 146 radially away from central axis 111.

Mold 140 of the illustrated embodiment includes two gates 144. However, in other embodiments, mold 140 can include any number of gates 144. In some embodiments, gates can be equally angularly spaced about central axis 111. Even spacing of gates about central axis can minimize a distanced traveled by any portion of the injected material before reaching fiber component, which can contribute to maintaining temperature and pressure of the injected material at intended levels.

In some embodiments, gates 144 can be located near the intended position of fiber component 114 within cavity 146 to reduce loss of pressure, heat, or both, from injected material between injection channel 142 and fiber component 114. In particular, gates 144 can be located near the intended position of exterior surfaces of fiber component 146.

In some embodiments, the position of fiber component 114 within cavity 146 while material is injected can be such that gates 144 are less than 5 mm away from fiber component 114, less than 3 mm away from fiber component 114, less than 2 mm away from fiber component 114, or less than 1 mm away from fiber component 114. Accordingly, injection mold 140 can be configured to hold fiber component 114 at a position less than 5 mm away from gates 144, less than 3 mm away from gates 144, less than 2 mm away from gates 144, or less than 1 mm away from gates 144. Injection mold 140 can be configured to hold fiber component 114 securely at such positions so that fiber component 114 remains entirely or generally stationary while material is injected into cavity 146. In some embodiments, configuration of injection mold 140 to hold fiber component 114 at such positions can be accomplished by shaping cavity 146 to receive fiber component 114 in the intended position and placing gates 144 so that forces exerted on fiber component 114 will not displace fiber component 114 from the intended position.

Positioning gates 144 near fiber component 114 can cause injected material to reach fiber component 114 at a high enough pressure and a low enough viscosity to permeate at least part of fiber component 114. Because the injected material permeates at least part of fiber component 114, the plastic component 110 that results when the injected material solidifies will be integrated with fiber component 114, thereby creating a secure attachment of plastic component 110 to fiber component 114. In some embodiments, the attachment of plastic component 110 to fiber component 114 formed this way can be stronger and more durable than some available methods of joining pre-formed plastic components to fiber components. In some embodiments, the composite article resulting from allowing the injected material to solidify into plastic component 110 integrated with fiber component 114 in this way can be a fitment 100 as described above.

In some embodiments, the molten material can be injected at a barrel temperature from 350° to 550° Fahrenheit. In further embodiments, the molten material can be injected at a barrel temperature from 400° to 500° Fahrenheit. In further embodiments, the molten material can be injected at a barrel temperature from 430° to 450° Fahrenheit. For example, in embodiments wherein fiber component 114 is made of paper fiber and the molten material is plastic, such as polypropylene or HDPE, injection at barrel temperatures from 430° to 450° Fahrenheit and adequate pressure can result in suitable permeation of the interstices of fiber component 114 by the molten material to create a strong bond between fiber component 114 and the resulting plastic component 110. Injection temperatures can vary depending on the respective compositions of fiber component 114 and the injected material, as well as parameters of the injection, such as the injection pressure of the molten material and the dimensions of mold cavity 146.

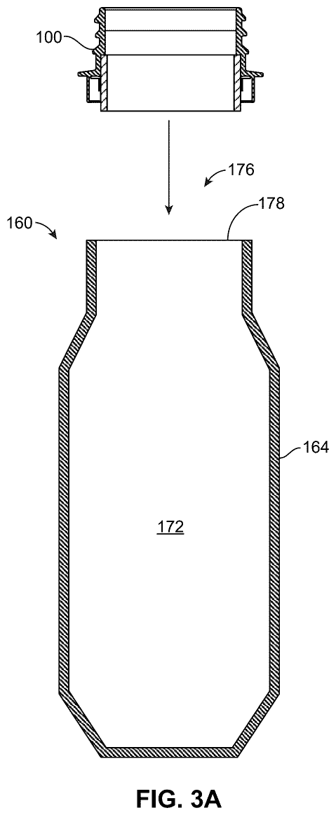

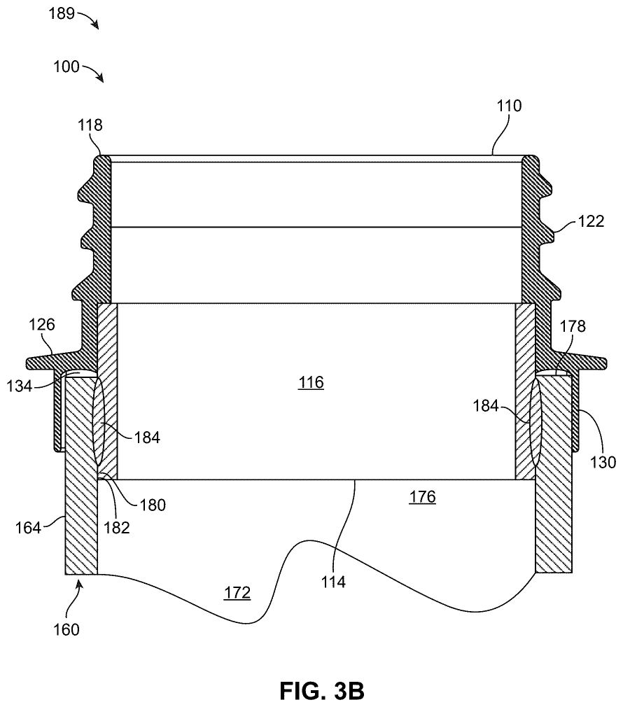

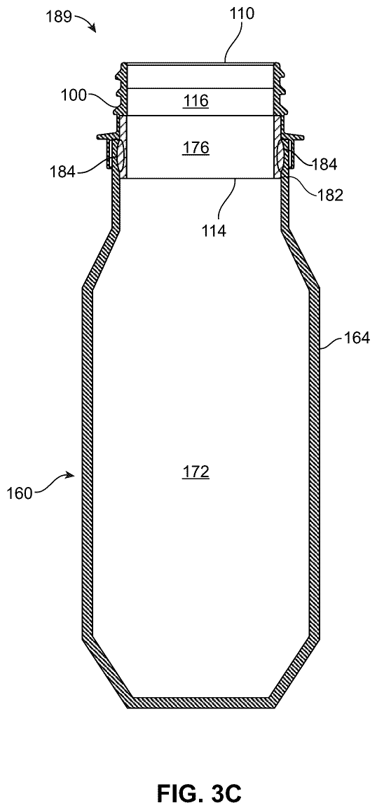

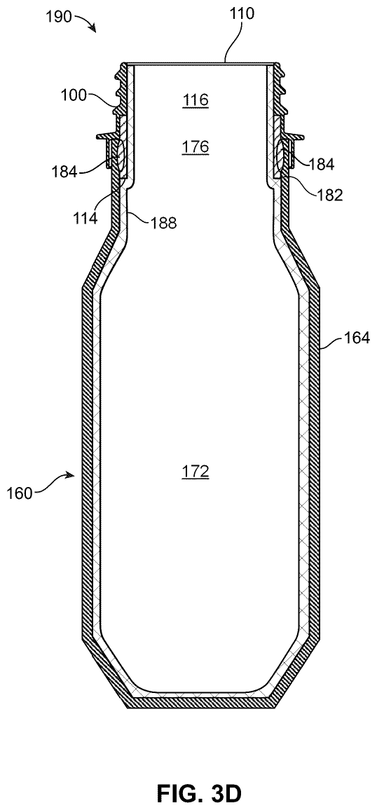

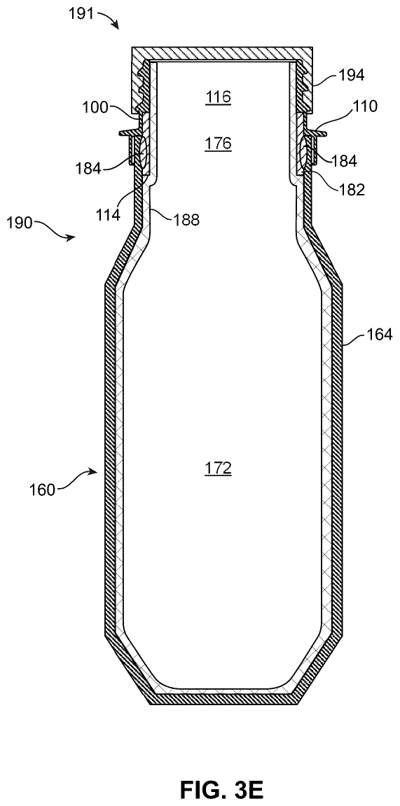

Turning to FIGS. 3A-3D, fitment 100 can be assembled together with a vessel 160 to form a bottle 190 shown in FIG. 3D. Bottle 190 is one example of an article that can be made in part by forming a plastic component on a fiber component as described above with regard to FIGS. 2A and 2B to form a composite element, such as fitment.

In some examples, bottle 190 (or other article formed or used based on the aspects described herein) can be formed of fiber in the form of flat fiber panels folded or otherwise joined (e.g., as in some types of milk cartons) or formed of fiber in the form of a three-dimensionally-formed molded fiber. However, other articles can also be made in part from such composite elements. For example, a plastic component can be formed on a fiber component to provide one or more parts to be assembled in a carton for storing liquids, a food carton (e.g., a molded-fiber egg carton), a clamshell package, other types of containers, or articles other than containers. The plastic component can be formed upon such fiber components in locations, shapes, and thicknesses as appropriate to achieve desired durability, strength, and impermeability to liquids and gases while maintaining a relatively low total weight and a relatively high proportion of fiber in the completed article.

In some embodiments, vessel 160 can be constructed at least partially of fiber material, such as any of the fiber materials from which fiber component 114 may be constructed. Thus, in some embodiments, vessel 160 can be constructed of fibrous material. Vessel 160 of the illustrated embodiment is generally bottle shaped. However, vessel 160 in other embodiments can be shaped otherwise, such as being generally box shaped to form a carton when assembled with fitment 100. For example, vessel 160 can include a wall 164 that bounds an interior 172 defined within vessel 160. In some embodiments, wall 164 can be constructed at least partially of fiber material. In some embodiments, wall 164 can be constructed entirely of fiber material. Thus, in some embodiments, wall 164 can include fibrous material. Wall 164 as used herein can refer to the structures providing one or more sides of vessel 160, a base of vessel 160, or both the base of vessel 160 and one or more sides of vessel 160.

As shown in FIG. 3B, in some embodiments fitment 100 can be attached to vessel 160 by binding fiber component 114 of fitment 100 to the fiber material of wall 164. A binder 184 can be applied between fiber component 114 and the fiber material of wall 164 to bind fiber component 114 and the fiber material of wall 164. For example, before assembling fitment 100 together with vessel 160, binder 184 can be applied to fiber component 114, wall 164, or both fiber component 114 and wall 164, at a location or locations that will cause binder 184 to contact both fiber component 114 and wall 164 when fitment 100 and vessel 160 are assembled together. Assembly 189 can include a joint 180 between fiber component 114 and wall 164. In some embodiments, fiber component 114 can meet wall 164 at joint 180. In some embodiments, binder 184 can be applied to fitment 100, vessel 160, or both fitment 100 and vessel 160, at a location or locations that will cause binder 184 to be located within joint 180 when fitment 100 and vessel 160 are assembled together. Binder 184 can be any material suitable for joining two fiber based articles together, such as glue.

It can be simpler and more economical to produce secure bonds between separate fiber based objects, such as fiber component 114 and wall 164, than to produce a comparably secure bond between a fiber based object and some varieties of solid plastic objects, such as plastic component 110 according to some embodiments. Thus, in some embodiments, a more secure bond between fiber component 114 and wall 164 may be created, such as by use of binder 184, than would be practical to achieve when attaching a conventional, completely polymer based fitment to a fiber based article such as vessel 160. Because plastic component 110 can be integrated with fiber component 114 as described above with regard to FIG. 2B, the attachment of fiber component 114 to the fiber material of wall 164 can create an effective chain of connection from vessel 160 to plastic component 110 that is more secure than may be practical to achieve directly between fiber based objects and some varieties of solid plastic objects.

Vessel 160 of the illustrated embodiment includes an opening 176 through which objects and substances can pass into or out of interior 172. When fitment 100 and vessel 160 are assembled to form assembly 189, fitment 100 can be positioned about opening 176. Thus, bottle 190 that includes assembly 189 of the illustrated embodiment includes both vessel 160 having opening 176 and fitment 100 positioned about opening 176. In some embodiments, fitment 100 can be assembled with vessel 160 to align passage 116 of fitment 100 with an opening 176 of vessel 160. Thus, in some embodiments, objects and substances can pass into and out of an interior 172 of a bottle 190 that includes an assembly 189 of fitment 100 and vessel 160 through passage 116 of fitment 100. In some such embodiments, objects and substances can be prevented from passing into or out of interior 172 by blocking passage 116, such as by applying a closure to fitment 100.

In some embodiments, fitment 100 can be shaped to mechanically engage vessel 160 when fitment 100 and vessel 160 are assembled. In some embodiments, wall 164 of vessel 160 can include a rim 178 surrounding opening 176. In some such embodiments, fitment 100 can mechanically engage vessel 160 by receiving rim 178 in gap 134 between barrier 130 and fiber component 114. In some such embodiments, a portion of wall 164 including rim 178 or adjacent to rim 178 can have a thickness equal to or slightly greater than a width of gap 134 to create an interference fit when received in gap 134. The interference fit of the portion of wall 164 received in gap 134 can create static friction between fitment 100 and vessel 160 that resists disassembly of fitment 100 and vessel 160. In some embodiments, mechanical engagement between fitment 100 and vessel 160 can complement the bond between fiber component 114 and wall 164 in resisting removal of fitment 100 from vessel 160. In some such embodiments, mechanical engagement between fitment 100 and vessel 160 can assist with maintaining fitment 100 and vessel 160 in an assembled state while binder 184 cures or dries.

As shown in FIG. 3D, after creating assembly 189 by assembling fitment 100 and vessel 160, if appropriate or necessary for the substance intended to be contained within bottle 190, a coating 188 can be applied to one, some, or all interior 172 facing surfaces of assembly 189. In some embodiments, applying coating 188 to assembly 189 can complete bottle 190. Coating 188 can be applied to fitment 100 or vessel 160. In some embodiments, coating 188 can be applied to both fitment 100 and vessel 160.

In some embodiments, coating 188 can be a substance suitable for contact with the intended contents of bottle 190. Thus, in embodiments wherein bottle 190 is intended to contain liquid, coating 188 can be a substance that is substantially impermeable to the liquid. For example, in some embodiments, coating 188 can be waterproof. In some embodiments, coating 188 can be impermeable to oil. Coating 188 in some embodiments can thus act to protect fiber component 114 and vessel 160 from the intended contents of bottle 190. Thus, in some embodiments, coating 188 can enable construction of a bottle 190 suitable for storing substances that would dissolve, pass through, or damage the fiber of which fiber component 114 or vessel 160 is constructed. For example, water and oil can soak through or break apart some fiber based materials from which fiber component 114 or vessel 160 may be constructed, but application of a waterproof or oil proof coating 188 can enable bottle 190 to be constructed partially from such fiber based materials and be suitable for storing substances containing water or oil.

In some embodiments, coating 188 can be food safe, making bottle 190 suitable for storing food, beverages, condiments, medicine, or other substances intended for human consumption. In some embodiments, coating 188 can have little or no permeability to certain gases. For example, in some embodiments, coating 188 can be impermeable to oxygen. In some such embodiments, coating 188 can contribute to preserving the contents of bottle 190.

In some embodiments, including the illustrated embodiment, coating 188 can be applied to extend from an interior 172 facing surface of vessel 160 to an interior 172 facing surface of fitment 100. Coating 188 can therefore seal off a joint between vessel 160 and fitment 100. In some embodiments, including the illustrated embodiment, coating 188 can extend from an interior 172 facing surface of wall 164 to an interior 172 facing surface of fiber component 114. Coating 188 can therefore extend across an interior end 182 of joint 180 between fiber component 114 and wall 164. By extending across interior end 182 of joint 180, coating 188 can seal joint 180 off from interior 172. In some embodiments, coating 188 can therefore prevent contents of interior 172 from reaching joint 180. Thus, coating 188 can protect binder 184 from the contents of interior 172. For example, a waterproof coating 188 can enable a bottle 190 having a water-soluble binder 184 to safely store water in interior 172 by preventing the stored water from contacting binder 184. Coating 188 can also prevent contamination of contents of interior 172 by binder 184. For example, a food safe coating 188 can enable a bottle 190 having a non-food safe binder 184 to safely store substances intended for human consumption in interior 172 by preventing the contents of interior 172 from contacting binder 184. Application of coating 188 can therefore enable binder 184 to be selecting independently of the intended contents of bottle 190. For example, use of coating 188 suitable for intended contents of bottle 190 can enable binder 188 to be selected primarily based on factors other than the intended contents of bottle, such as, for example, bond strength, durability, economy, and environmental friendliness.

Fitment 100 together with a vessel 160 constructed at least partially of fiber material can result in a bottle 190 of which fiber material includes a significant portion of the total weight. For example, a bottle 190 that includes an assembly of fitment 100 together with a vessel constructed at least partially of fiber material can be at least 85%, at least 87.5%, at least 90%, at least 92.5%, at least 95%, or at least 97.5% fiber material by weight. Thus, bottle 190 in some embodiments can include a greater proportion of fiber than could be practical to construct from the same vessel 160 and a conventional fitment made entirely of plastic. Bottles that include an assembly of fitment 100 and a vessel 160 constructed at least partially of fiber material can therefore be useful in meeting recyclability standards based on the proportion of an article's total weight provided by natural fiber or other recyclable material.

Recyclability standards for articles containing fiber based materials vary internationally. For example, in some places articles with as little as 80% natural fiber content by weight may be recycled, whereas in other places articles are required to have as much as 95% natural fiber content by weight to be considered recyclable. The techniques disclosed herein can be used to produce composite articles having relatively high fiber content in proportion to their total weight. The techniques disclosed herein may therefore be useful for meeting even the most stringent recyclability standards based on fiber content. Further, the techniques disclosed herein may be useful for creating cost-efficient and securely assembled articles that meet recyclability standards.

As further shown in FIG. 3E, a closure 194 can be engaged to fitment 100 after completion of bottle 190 to form a container 191. Closure 194 of the illustrated embodiment engages fitment 100 by threading onto threading 122 of fitment 100. However, in other embodiments, closure 194 can engage fitment 100 by other mechanisms, such as, for example, by press-fitting into passage 116. In some embodiments, closure 194 can seal passage 116 of fitment 100 while engaged to fitment 100. In embodiments such as the illustrated embodiment wherein fitment 100 is positioned at and about opening 176 of vessel 160 to align passage 116 with opening 176, closure 194 can therefore be used to prevent objects and substances from passing into or out of interior 172. In some embodiments, container 191 can be at least 85%, at least 87.5%, at least 90%, at least 92.5%, at least 95%, or at least 97.5% fiber material by weight.

Usage of plastic component 110 to form an outlet of bottle 190 as shown in the illustrated embodiment can provide certain benefits achievable with plastic bottles that would be difficult to achieve with bottles constructed entirely from natural fibers. For example, closure 194 may be able to create a seal on plastic component 110 more reliably than on a natural fiber based material. Some consumers may also prefer the mouth feel of drinking from plastic component 110 to the mouth feel of drinking from an outlet constructed from natural fibers.

The usage of fitment 100 to construct a container 191 including a closure 194 and a bottle 190 as shown in FIGS. 1A-3E is one example of an application of the concepts disclosed herein. However, the concepts disclosed herein can be used to create articles other than the illustrated container 191. Composite fitments including a fiber component and a non-fiber component integrated into the fiber component can be used to construct other types of containers, such as, for example, cartons or drums. The other types of containers can include composite fitments having shapes other than the shape of fitment 100 of the illustrated embodiment, fiber based vessels having shapes other than the shape of vessel 160 of the illustrated embodiment, or both. Moreover, the concepts relating to the creation of composite articles illustrated by the above described process of creating fitment 100 can be used to create composite articles other than fitments. Generally, by forming a non-fiber component upon a fiber component such that the non-fiber component permeates at least part of the fiber component, an article may be produced that has some of the advantages of certain fiber materials, such as light weight and environmental friendliness, while having the properties of the non-fiber material where needed. Further, composite articles, whether in the form of fitments or otherwise, can be assembled into objects other than containers. Assemblies in the form of containers or other objects can include composite articles in addition to features at least partially made from fiber, and the at least partially fiber features can be bonded to the fiber component of the composite article to create an effective chain of connection from the at least partially fiber features to the non-fiber component of the composite article. In further embodiments, porous, but non-fibrous materials can be used in place of or in addition to fiber in any of the articles, objects, or assemblies disclosed herein. Similarly, in further embodiments, the non-fiber portions of composite articles and assemblies disclosed herein can include materials other than plastic instead of or in addition to plastic.

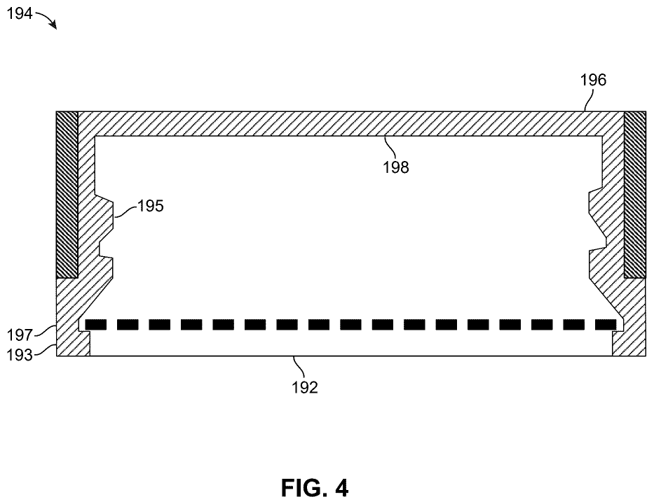

Turning to FIG. 4, in some embodiments, closure 194 can also be a composite article. In the illustrated embodiment, closure 194 includes a fiber component 196 and a plastic component 192. Like fiber component 114 of fitment 100, fiber component 196 of closure 194 of the illustrated embodiment can be a ring. In other examples, fiber component 196 could further include a portion extending across a top of a cover 198 portion of closure 194 such that fiber component 196 would have a cup shape or bowl shape. Fiber component 196 of closure 194 can be made of any of the materials described above with regard to fiber component 114 of fitment 100. Plastic component 192 of closure 194 can be made of any of the materials described above with regard to plastic component 110 of fitment 100. Thus, in some embodiments, closure 194 can be produced by a similar process to that described above with regard to FIGS. 2A and 2B in relation to production of fitment 100. That is, flowable material can be injected into a mold cavity in which fiber component 196 is disposed to form plastic component 192 on fiber component 196. In some embodiments, the plastic of plastic component 192 extend into fiber component 196. In some embodiments, the plastic of plastic component 192 can permeate some of the fiber of fiber component 196.

Closure 194 of the illustrated embodiment is in the form of a threaded cap configured to threadedly engage fitment 100. Thus, closure 194 of the illustrated embodiment is threaded to engage threading 122 of fitment 100. Threading 195 of closure 194 can be formed in plastic component 192. Thus, closure 194 can include plastic threading 195 to cooperate with plastic threading 122 of fitment 100.

In some embodiments, plastic component 192 can also include a cover 198 configured to cover passage 116. Cover 198 can therefore be used to seal opening 176 of bottle 190 when fitment 100 is assembled together with vessel 160 to form bottle 190. In embodiments wherein cover 198 is formed in plastic component 192, fiber component 196 can be formed of material unable to create a seal upon fitment 100. Thus, construction of closure 194 as a composite article can enable closure 194 to retain some advantages associated with fiber materials, such as light weight and recyclability, while having the mechanical properties of other materials, such as plastic, where needed.

In some embodiments, closure 194 can include a tamper proof band 193. Tamper proof band 193 can be connected to the remainder of closure 194 by a frangible portion 197 of material. As shown in the illustrated embodiment, the frangible portion 197 of material can be perforated. Tamper proof band 193 can be configured to engage fitment 100 when closure 194 is first applied to fitment 100 and to break away from the remainder of closure 194 when closure 194 is subsequently removed from fitment 100, thereby indicating whether bottle 190 has been opened since its initial fill. In some embodiments, tamper proof band 193 can be part of plastic component 192. In some such embodiments, tamper proof band 193 can therefore be formed with similar processes as those used to created removable bands on closures made entirely from plastic, and may therefore function similarly to such other removable bands.

The foregoing concepts may be leveraged in a method 200 of lightweighting an article of manufacture. The article of manufacture may be an article for which conventional methods of forming the article from injection molded, or otherwise non-porous, material already exist. In some embodiments, method 200 can achieve a conversion of the article of manufacture to a composite structure that comprises a relatively light, porous material and a relatively heavy, injection molded material.

Method 200 can include a material selecting step 210. Material selecting step 210 can include selecting materials to be used in the composite structure. Material selecting step 210 can include selecting a lightweight porous material and an injectable material to be injected onto the porous material. In some embodiments, the porous material can be any of the fiber based or otherwise porous materials described elsewhere herein, including those described as materials for fiber component 114. In some embodiments, the injectable material can include any of the injection moldable materials described elsewhere herein, including those described as materials for plastic component 110.

In some embodiments, material selecting step 210 can include selecting a binder to bind a first porous object to a second porous object at a joint.

Method 200 can include a surface identifying step 220. In some embodiments, surface identifying step 220 can include identifying surfaces of the article of manufacture that have purposes necessitating a particular one of the materials to be used in the composite structure. In further embodiments, surface identifying step 220 can include identifying surfaces of the article of manufacture that do not have purposes necessitating a particular one of the materials to be used in the composite structure. In further embodiments, surface identifying step 220 can include identifying surfaces of the article of manufacture that have purposes for which any of the materials to be used in the composite structure are unsuitable.

In some embodiments, surface identifying step 220 can include identifying a first surface that does not have a purpose that requires the injection molded material. For example, where the article of manufacture being lightweighted is a bottle, surface identifying step 220 can include identifying an exterior surface of the bottle as a first surface that does not have a purpose that requires the injection molded material because the exterior surface of the bottle is not expected to be exposed to stresses or substances for which the porous material would be unsuitable.

In another example, surface identifying step 220 can include identifying a threaded portion of the bottle as a second surface that has a purpose requiring the injection molded material because the threads of the bottle are expected to be exposed to stresses that would cause the porous material to fail. In another example, surface identifying step 220 can include identifying an interior facing surface of the bottle as a second surface that has a purpose requiring the injection molded material if the interior facing surface of the bottle is expected to be exposed to substances that would cause the porous material to fail and no coating material is to be applied.

In another example, if a binder is to be used in the composite structure, surface identifying step 220 can comprise identifying a third surface having a purpose incompatible with the binder. For example, as described above with regard to assembly 189 and binder 184, some binders with advantageous mechanical properties when used to join porous elements may be unsuitable for contact with food. Accordingly, surface identifying step 220 can comprise identifying a surface of the composite structure expected to contact food as a third surface having a purpose incompatible with the binder.

Method 200 can also include a subdividing step 230 after surface identifying step 220. Subdividing step 230 can include subdividing a net shape of the injection molded article of manufacture into a first section and a second section to be formed of different materials. Subdividing step 230 can include weighing factors such as total weight, mechanical properties, and manufacturing cost while complying with the material requirements of specific surfaces found in surface identifying step 220 to arrive at an optimal composite structure that is lighter in weight than a previous design for the article of manufacture.

Subdividing step 230 can include further subdividing any sections into multiple objects of a same material. For example, in some embodiments, subdividing step includes further subdividing the first section into a porous assembly that includes a first porous object and a second porous object. The porous assembly can have a shape matching the first section.

For example, the first section can include a region to be formed of a porous component. Thus, in some embodiments, subdividing step 230 can include including the first surface identified in surface identifying step 220 in the first section. The porous component can be, for example, the fiber component 114 described above. In another example, the second section can include a region to be formed of injection molded material. Thus, in some embodiments, subdividing step 230 can include including the second surface identified in surface identifying step 220 in the second section. The region to be formed of injection molded material can correspond to, for example, the plastic component 110 described above.

In some embodiments wherein surface identifying step 220 includes identifying a third surface having a purpose unsuitable for one of the substances to be used in the composite structure, method 200 can include a seal planning step 240. Seal planning step 240 can include planning a placement of a seal material to seal off the unsuitable substance from the third surface. Thus, in some embodiments wherein the second section is to be formed of a first porous object and a second porous object bound at a joint by a binder, seal planning step 240 can include identifying a coating location at which coating, when placed, will seal off the joint from the third surface identified in surface identifying step 220. For example, when method 200 is used to design assembly 189 described above, seal planning step 240 can include planning a placement of coating 188 to seal off binder 184 from any surface of assembly 189 expected to contact food.

In some embodiments, seal planning step 240 occurs after subdividing step 230 and before fabricating step 250. Seal planning step 240 can be omitted in any embodiments wherein surface identifying step 220 does not include identifying any surfaces from which any substances to be used in the composite structure must be sealed away. Thus, in some embodiments, method 200 proceeds from subdividing step 230 to fabricating step 250 without planning step 240 in between.

Fabricating step 250 can include fabricating a porous object corresponding to some or all of the first section from subdividing step 230. In some embodiments, fabricating step 250 includes fabricating a porous object having a shape matching a portion of the first section. In further embodiments, fabricating step 250 includes fabricating a porous object having a shape matching an entirety of the first section. The porous object fabricated in fabricating step 250 can be, for example, fiber component 114.

After fabricating step 250, method 200 includes a placing step 260. Placing step 260 includes placing the porous object into an injection mold cavity. In some embodiments, the injection mold cavity can be alike to cavity 146 described above. In some embodiments, placing step 260 includes placing the fiber object fabricated in fabricating step 250 into the injection mold cavity in the same manner illustrated and described above with respect to the placement of fiber component 114 in cavity 146.

After placing step 260, method 200 includes injecting step 270. Injecting step 270 includes injecting a molten material into the injection mold cavity at a great enough pressure to force the molten material into pores of the porous object. In some embodiments, injecting step 270 can be alike in any or all respects to the injection of molten material into cavity 146 and fiber component 114 as described above.

In some embodiments wherein subdividing step 230 comprises further dividing the second section into multiple porous objects, method 200 comprises an assembling step 280 after injecting step 270. Assembling step 280 can include forming a porous assembly having a shape matching the first section. The porous assembly can include the porous object from fabricating step 250, placing step 260, and injecting step 270 in addition to a second porous object. Assembling step 280 can further include using a binder to bind the porous objects together at a joint. Assembling step 280 can be used, for example, to construct assembly 189 by using binder 184 to bind fiber component 114 of fitment 100 to fiber vessel 160 at joint 180. Assembling step 280 can be omitted in some embodiments, including some embodiments where the first section and second section correspond to monolithic parts of the lightweight composite structure.

In some embodiments, method 200 can include a joint sealing step 290 following assembling step 280. Joint sealing step 290 includes sealing a joint formed between adjoining objects during assembling step 280. Joint sealing step 290 can include applying a coating to the coating location determined in seal planning step 240. In some embodiments, joint sealing step 290 can therefore include applying a coating to seal off a joint containing a binder from a third surface of an assembly. In further embodiments, joint sealing step 290 can include applying a coating to seal off a joint from substances that may undesirably infiltrate an unsealed joint. The third surface has a purpose for which the binder is unsuitable. Joint sealing step 290 can be omitted in some embodiments that lack assembling step 280. Joint sealing step 290 can also be omitted in some embodiments that include assembling step 280, but lack a binder that must be sealed away from certain surfaces of the composite structure, or embodiments wherein no substances that may undesirably infiltrate the joint are expected to contact the composite structure near the joint.

It is to be appreciated that the Detailed Description section, and not the Summary and Abstract sections, is intended to be used to interpret the claims. The Summary and Abstract sections may set forth one or more but not all exemplary embodiments of the present disclosure but are not intended to limit the present disclosure and claims in any way.

The foregoing description of the specific embodiments so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present disclosure should not be limited by any of the above-described exemplary embodiments, but should be defined only in accordance with the claims and their equivalents.

What is claimed is:

1. A fitment for a bottle, the fitment comprising:
a fiber ring constructed of fiber based material, wherein the fiber based material comprises a mass of fibers defining interstices among the fibers; and
a plastic collar comprising a plastic, wherein the plastic collar is joined to the fiber ring and some of the plastic permeates some of the interstices of the fiber ring.

2. The fitment of claim 1, wherein the plastic collar comprises a threaded portion.

3. The fitment of claim 1, wherein the threaded portion is externally threaded.

4. A bottle comprising:
a vessel comprising an opening; and
the fitment of claim 1, wherein the fitment is positioned at the opening.

5. The bottle of claim 4, wherein the vessel comprises a wall, and the wall comprises fiber based material.

6. The bottle of claim 5, wherein fiber comprises at least 90% of the bottle by weight.

7. The bottle of claim 5, wherein fiber comprises at least 95% of the bottle by weight.

8. The bottle of claim 4, comprising a binder that binds the fiber ring to the vessel.

9. The bottle of claim 8, wherein the vessel comprises a fiber portion constructed of fiber based material, and the binder binds the fiber portion of the vessel to the fiber ring.

10. The bottle of claim 4, comprising a coating applied to interior facing surfaces of the fitment and the vessel.

11. The bottle of claim 10, comprising:
an interior of the bottle defined within the vessel; and
a joint between the fiber ring and the vessel, wherein the coating seals off the joint from the interior of the bottle.

12. A method of manufacture comprising:
forming a composite article by injecting a molten material into an injection mold cavity while a fiber based object is disposed in the injection mold cavity at a great enough pressure to force the molten material into interstices between fibers of the fiber based object.

13. The method of claim 12, comprising binding the fiber based object to a fiber based article after forming the composite article.

14. The method of 12, wherein the composite article is a fitment for a bottle, the molten material is a plastic, and the fiber based object is a fiber ring.

15. The method of claim 14, wherein the injection mold cavity has a shape of a fitment for a bottle.

16. The method of claim 14, wherein the injection mold cavity comprises a finish portion and a thread portion adjoining the finish portion.

17. The method of claim 16, comprising injecting the plastic into the injection mold cavity while the fiber ring extends into the finish portion.

18. The method of claim 16, comprising injecting the plastic into the injection mold cavity through a gate that opens into the finish portion.

19. The method of claim 18, wherein the gate is less than one millimeter away from the fiber ring.

20. The method of claim 19, comprising injecting the plastic into the injection mold cavity in an outward direction relative to a central axis of the fiber ring.

21. A method of lightweighting an injection molded article of manufacture, the method comprising:
subdividing a net shape of the injection molded article of manufacture into a first section and a second section, wherein the first section comprises a region to be formed of a porous component, and the second section comprises a region to be formed of injection molded material;
fabricating a porous object having a shape matching a portion of the first section;
placing the porous object into an injection mold cavity; and
injecting a molten material into the injection mold cavity at a great enough pressure to force the molten material into interstices between pores of the porous object.

22. The method of claim 21, wherein the subdividing step comprises:
identifying a first surface of the injection molded article of manufacture that does not have a purpose that requires the injection molded material;
identifying a second surface of the injection molded article that has a purpose that requires the injection molded material; and
including the first surface in the first section and including the second surface in the second section.

23. The method of claim 21, wherein the porous object is a porous object, and comprising forming a porous assembly having a shape matching the first section, wherein the porous assembly comprises the first porous object and a second porous object.

24. The method of claim 23, comprising forming the porous assembly after injecting the molten material into the injection mold cavity.

25. The method of claim 23, comprising:
selecting a binder to bind the first porous object to the second porous object at a joint;
identifying a third surface of the porous assembly that has a purpose incompatible with the binder; and
identifying a coating location at which coating, when placed, will seal the joint away from the third surface.
